(19) United States
(12) Patent Application Publication
(10) Pub. No.: US 2025/0245116 A1
(43) Pub. Date: Jul. 31, 2025

(54) SYSTEM AND METHOD FOR WORKFORCE TASK IDENTIFICATION USING FINGERPRINT DETECTION

(71) Applicant: Pegasystems Inc., Cambridge, MA (US)

(72) Inventors: Stephen Thomas Jacquemin, Mableton, GA (US); Kleber Stroeh, Campinas/SP (BR)

(21) Appl. No.: 18/428,414

(22) Filed: Jan. 31, 2024

(51) Int. Cl. G06F 11/30; G06F 11/34

(52) U.S. Cl. CPC G06F 11/3072; G06F 11/3438

(57) ABSTRACT

A system and method for workforce task identification includes monitoring desktop activities of a workforce. A fingerprint detection technique is used to identify desktop activities, such as time stamp data which may include user ID, application, and screen. A process may include data gathering and filtering, data transformation, matrix generation, determining an optimal number of clusters, and generating candidate clusters.

### TECHNICAL FIELD

The present disclosure is related to identifying tasks in a sequence of activities performed by a workforce having access to different software applications.

### BACKGROUND

Many organizations have a variety of tasks performed by their workforce using a variety of different software applications. Tasks are sequences of activities which resources step through to accomplish specific objectives. In the context of task-mining, these could be specific sequences of software applications, sequences of combinations of applications and their respective screens, or sequences of other types of desktop activity such as keystrokes, mouse clicks, or data entries. For example, a financial services provider client may have distinct tasks pertaining to opening and closing accounts, ordering paper checks, transferring money between accounts and many others

As another example, each employee doing customer service may be issued a desktop computer licensed to use a variety of different software applications. Individual customer support individuals may, for example, address customer issues using a sequence of applications and user screens on their desktops to perform tasks. For example, in customer service functions, an employee may navigate between different application user screens to resolve a customer problem.

One of the problems in task mining is determining what tasks the workforce is actually using. For example, different customer support representatives may use different sequences of software applications and screens to solve the same customer service problem. Also, over time, customer service representatives may adapt their use of software to adapt to changes in software tools, company policies, or customer needs. Another related problem after a task has been identified is determining the typical set of activities that make up the task.

One solution to these problems is to interview subject matter experts, managers, or other stakeholders. However, this approach is expensive in time and money. This approach is also prone to inaccuracy due to the subjective lenses of interviewees.

### SUMMARY

A system and method for task mining includes task identification. An example method of task identification in a workforce includes gathering time series data of resources, computer apps, and computer screens for desktop activities of a workforce; performing pre-processing of time series data, including filtering the time series data and performing at least one data transformation operation to convert the time series data into a data representing desktop activities, distances between activities, and counts; generating a matrix of activities from the data representing desktop activities, distances between activities, and counts; determining an optimum number of clusters for the filtered and transformed data; clustering the filtered and transformed time series data into the optimum number of clusters; and generating a list of candidate tasks from the clusters.

In one implementation, the method includes generating a list of candidate tasks from the clusters based on a frequency-threshold criteria, a minimum number of activities threshold, and a median distance threshold.

In one implementation, the method includes determining an optimum number of clusters comprises plotting task candidates on a y-axis and an increasing number of clusters on an x-axis.

In one implementation, the method includes comprising assessing numeric measures of cluster quality.

In one implementation of the method, the transformation operation includes generating a count matrix and a distance matrix.

In one implementation, the method further includes generating a single matrix from the count matrix and the distance matrix to generate a distance matrix having a weighted average.

### BRIEF DESCRIPTION OF THE DRAWINGS

FIG. 1 illustrates a general environment for performing task identification of workforce desktop processes in accordance with an implementation.

FIG. 2 illustrates process of task identification in accordance with an implementation.

FIG. 3 illustrates an example of user-app-screen timestamp instances in accordance with an implementation.

FIG. 4A is a flowchart of an example of a data gathering and filtering processing in accordance with an implementation.

FIGS. 4B and 4C illustrate examples of data gathering and filtering in accordance with an implementation.

FIG. 5 is a flow chart of a method in accordance with an implementation.

FIG. 6 illustrates restructured filtered time series data reorganized into a table with three columns for the Resource ID, the activity, and a list of sequence location in order by timestamp in accordance with an implementation.

FIG. 7 illustrates distance matrix and count matrix in accordance with an implementation.

FIG. 8 illustrates aspects of calculating minimum distance, average, and count in accordance with an implementation.

FIG. 9 illustrates an example of an average distance matrix in accordance with an implementation.

FIG. 10 illustrates the elbow method of determining a number of clusters in accordance with an implementation.

FIG. 11 illustrates an aspect of a method of determining a number of clusters in accordance with an implementation.

FIG. 12 illustrates a frequency table for one cluster in accordance with an implementation.

FIG. 13 illustrates a distance table for one cluster in accordance with an implementation.

### DETAILED DESCRIPTION

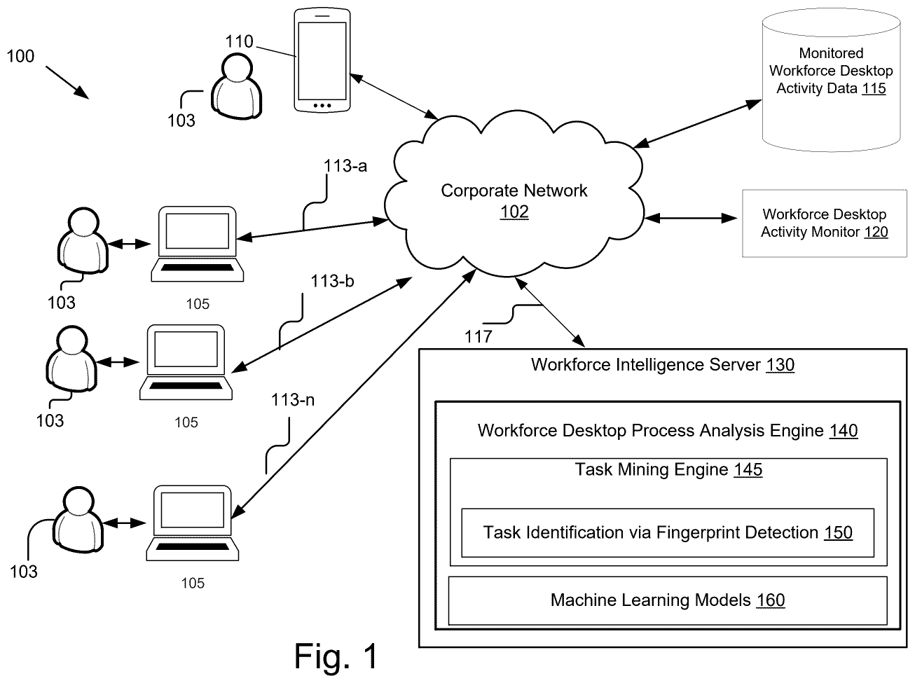

FIG. 1 is a block diagram of a high-level system 100 for an enterprise to generate workforce intelligence regarding the tasks performed by members 103 of their workforce via software applications executing, for example, on desktop computers 105 or other computing devices such as smartphones 110. For example, each computing device may have a network connection 113 to a corporate network 102. The desktop activity of the workforce may be monitored by a workforce desktop activity monitor 120 and data stored in a database 115 to record, for example, the apps uses and screens used to perform tasks.

A workforce intelligence server 130 generates various forms of intelligence about the workforce but in one implementation includes a workforce desktop process analysis engine 140 to analyze desktop processes. A task mining engine 145 mines information about tasks performed by a workforce. A task identification via fingerprint detection unit 150 is included to identify tasks performed. In some implementations, one or more machine learning models 160 are included.

Tasks are sequences of activities which resources step through to accomplish specific objectives such as opening and closing accounts, filing an insurance claim, etc.

Correctly identifying tasks performed by a workforce can uncover insights such as: unnecessary complexity in the number of activities; unnecessary friction (typing, mouse clicks, scrolling, etc.); excessive data movement (e.g., copy/pastes); and rework. Such insights can be used by an organization to take actions such as coaching employees or automating unnecessary tasks.

Some exemplary definitions are useful to describe how task identification is performed. In one implementation, an activity is a specific application, screen or other type of desktop activity used to execute work. An example activity includes a combination of an application and a screen such as “Microsoft Excel—/—Claim Amount Calculation Worksheet”.

A resource is a distinct human (or robot in the case of Robotics Process Automation (RPA)) who can execute work. As an example of a resource, consider a customer service representative (CSR) at a call center who handles customer calls involving auto insurance claims. The CSR in this example is a human resource who can execute work.

A task is a set of activities that a resource steps through to accomplish a distinguishable piece of work. An example task could be a customer call involving an auto insurance claim. To handle an auto insurance claim, an insurance CSR may have to access different applications/screens to confirm a caller's policy information, record information about a claim, and process the claim.

An instance of a task is one distinct execution of the task by one resource over a specific timeframe. For example, the customer call involving the auto insurance claim for John Doe's auto accident which was handled by CSR Jenny from 3 pm to 3:15 pm on Jul. 11, 2022.

An event is an instance of an activity pertaining to a specific instance of a task at a specific time. For example, one usage of “Microsoft Excel—/—Claim Amount Calculation Worksheet” at 3:01 pm on Jul. 11, 2022, during the customer call involving John Doe's auto accident.

Of course, in the example of an insurance company, the insurance company may have many CSRs handing different claims over the course of a year. If there are multiple resources identified in the data, one assumption that can be made is that typically each instance of a task involves only one resource. For the purposes of illustration, let's say one of the tasks discovered by the algorithm is a type of customer call involving an auto insurance claim. Many different CSRs can execute different instances of the auto claim task (i.e. different customer calls), but typically only one CSR is executing one specific customer call.

If events corresponding to two or more specific activities repeatedly happen close to each other in time relative to events for other activities, said activities are likely part of a task.

The more times events corresponding to two or more specific activities repeatedly happen close to each other, the more likely said activities are to be part of a task.

### Exemplary Process for Task Identification

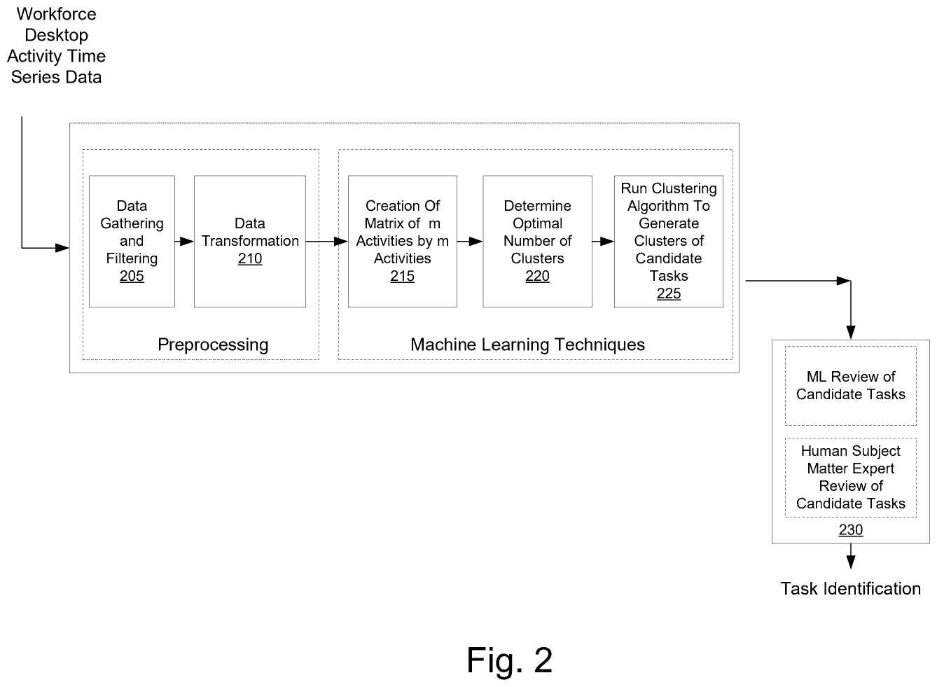

FIG. 2 illustrates an example method for converting workforce desktop activity data into identified tasks. In block 205 data gathering and filtering is performed. In block 210, data transformation is performed. In block 215, a matric of m×m activities is created. In block 220, an optimal number of clusters is determined. In block 225, clusters are generated of candidate tasks. In block 230, additional verification or validation may be performed. The output is a set of tasks.

Additional details of an example implementation are described below.

### Data Gathering and Filtering

In regard to the data gathering and filtering the data 205 of FIG. 2, in one implementation the time-series data includes at least two features: some activity of interest and a timestamp. If there are multiple resources executing the tasks, a feature is needed corresponding to the specific resource. For example, if Bob, Sam, Kathy, and Jill are the resources, a feature is needed to identify them.

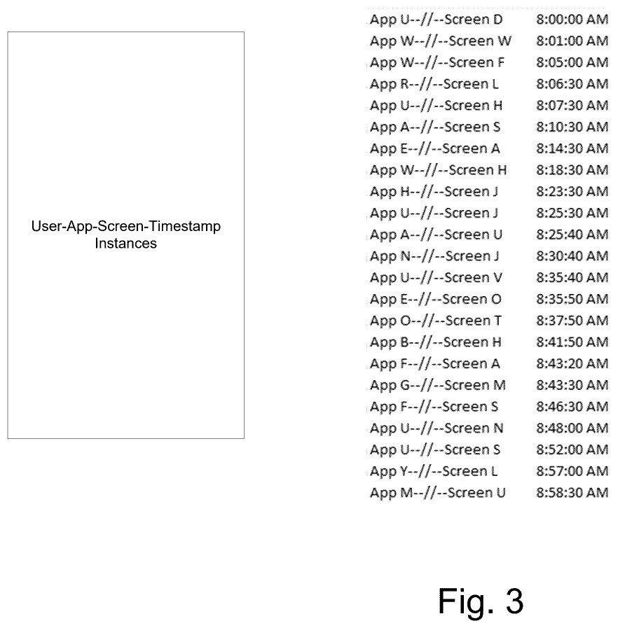

FIG. 3 illustrates time-stamped instances of the use of particular apps and screens for a particular resource. If there is more than one resource, the resource can also be identified (e.g., Bob Smith).

The example of FIG. 3 is specific to mining a resource's desktop activities, but the techniques discussed from here on will work with many different processes mining and or task mining datasets so long as they have these 2-3 required features. Likewise, the specific filtering steps discussed below can be generalized to other datasets, with the goal of filtering being the removal of irrelevant activities.

As an illustrative example, assume the process is collecting time-series data from a resource's desktop PC, specifically the application and screen the resource was on during a given period of time. An example of this kind of time-series data is shown in FIG. 3.

The first few rows of the data from FIG. 3 can be interpreted as follows: the resource was using screen “D” of the application “U” from 8:00 AM to 8:01 AM. The resource then navigated to screen “W” of application “W” at 8:01:00 AM and continued using that application/screen combination from 8:01 AM to 8:05 AM.

For simplicity, a single letter (i.e., “A”, “B”, “C”, etc.) is used to refer to the level of activity of interest, which could include the application/screen combination, the application only, the screen only, or some other type of desktop activity.

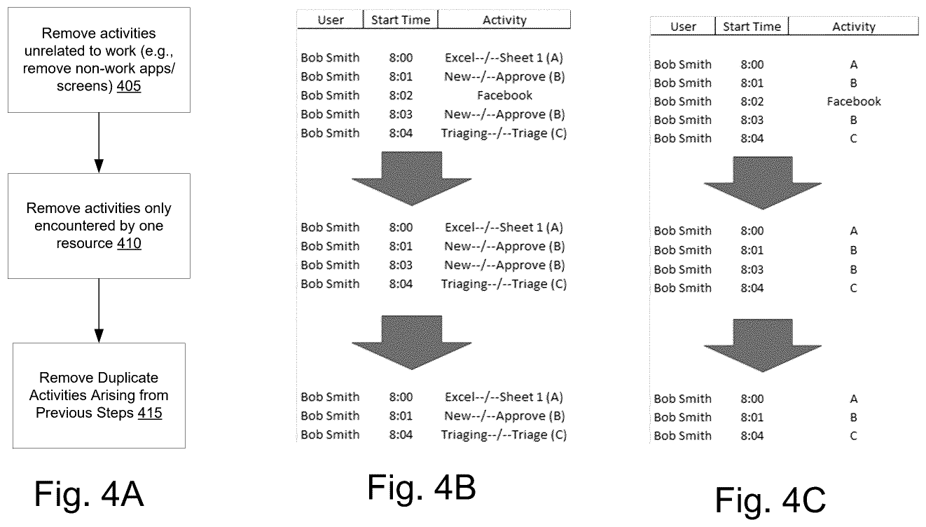

Referring to FIG. 4A, a number of filtering steps are applied. First, filtering is performed of the dataset to only include activities which are classified by the client as representing structured or other work. In modern workforces, employees sometimes do non-work activities during breaks. In block 405, activities unrelated to work are removed. If the goal is to capture a work-related process, the process needs to filter out things like resources checking their social media during downtime or chatting to a colleague through a messaging application about where to go for lunch. As an example, non-work apps and screens can be defined for a particular workforce and filtered out of the time series data. For example, in many work environments it would be unlikely for members of the workforce to access social media apps and screens. For example, an insurance claim agent is unlikely to use social media apps to deal with an automobile insurance claim.

In block 410, activities encountered by only one resource are removed. The reason for this type of filtering is that typically workforce intelligence is interested in identifying frequent processes executed by multiple resources. As such, an activity only performed by a single resource in isolation is not particularly helpful. This rule could be generalized to be any rule to filter out infrequent processes. For example, the rule could be generalized to filter out activities that are performed by only a small number of resources, by a small percentage of resources, or processes only used a statistically small percentage of the time.

In block 415, duplicate activities are removed that could have arisen due to the prior two pre-processing steps. For example, a resource may be using an Excel screen to do productive work, take a break to use social media, and return to using the same Excel screen to do work.

Consider FIG. 4B (top) showing an initial sequence of time-series data prior to removal of non-work screen and removal of apps/screens encountered only once. For example, if the initial time series data sequence: ‘A’, B, Facebook, ‘B’, ‘C’, where ‘A’, ‘B’ and ‘C’ represent structured or other work apps, the first pre-processing step would cull the sequence to remove the Facebook access, resulting in FIG. 4B (middle) to now be: ‘A’, ‘B’, ‘B’, ‘C’. After removing duplicate in FIG. 4B (bottom), we then end up with the sequence: ‘A’, ‘B’, ‘C’. In this example, each activity is a combination of an app and a screen, which can be represented by a letter (FIG. 4C).

### Data Transformation

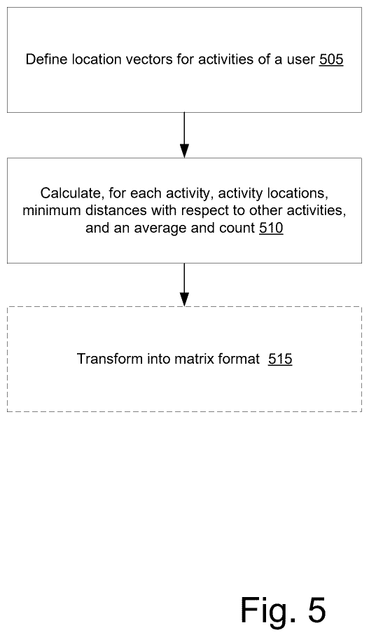

FIG. 5 illustrates at a high level some of the steps in data transformation, matrix transformation and matrix generation. Location vectors for activities of a user are defined in block 505. Activity location and minimum distances with respect to other location are determined in block 510. This data is transformed into a matrix format in block 515. A matrix format has many advantages for performing machine learning processing to determine an optimum number of clusters and generating candidate tasks.

A more detailed data transformation will now be discussed. To identify a task, various metrics may be generated indicative of distance of activities and frequency.

Referring back to the Data Transformations 210 of FIG. 2, while different data transformations are possible, in one implementation a distance matrix and a count matrix are formed based on defining activities, activity locations, minimum distance, and an average and count. This corresponds to creating two u×m×m matrices. Let a and b be the location vectors of two activities for user k. Assume without loss of generality that dim a<=dim b. Then we define f_{abk}=f_{bak}=dim a and we can have the following equation:

$${d}_{abk} = {d}_{bak} = \frac{{\sum }_{x = 1}^{dim a} min \{ \vert {a}_{x} - {b}_{y} \vert ∀ 1 < = y < = dim b \}}{dim a}$$

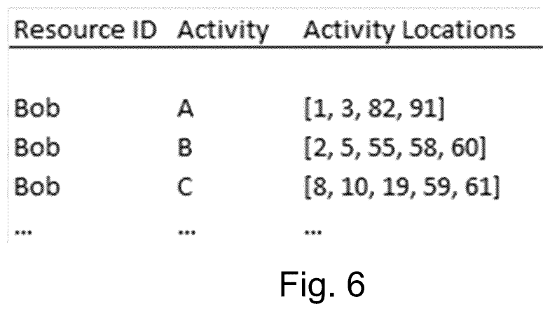

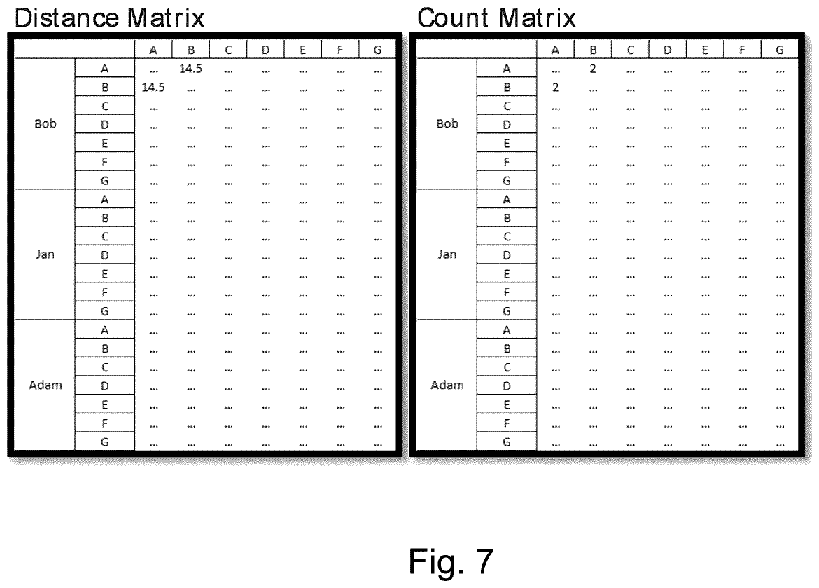

The activity location vectors from FIG. 6 are the inputs to the above equation. to create number needed to populate FIG. 7.

One can interpret the first row of the data from FIG. 6 as follows: Bob encountered activity ‘A’ as the very first activity during his day (or whatever timespan we are analyzing). Bob then encountered activity ‘B’ which was the second activity of his day (see row 2). Bob then encountered ‘A’ again as the third activity and didn't encounter ‘A’ again until the eighty-second activity of his day. This of course can be extended to include all of the apps/screens used by Bob to perform his work. This can also be extended to include similar information for other resources IDs (e.g., Kathy, Jill, Jim, etc.)

The transformed data in the format of FIG. 6 is used to create two new matrices with dimensions u×m×m, with ‘u’ representing the resources analyzed and ‘m’ representing the unique activities. This matrix format can be seen in FIG. 7 which shows a distance matrix and a count matrix.

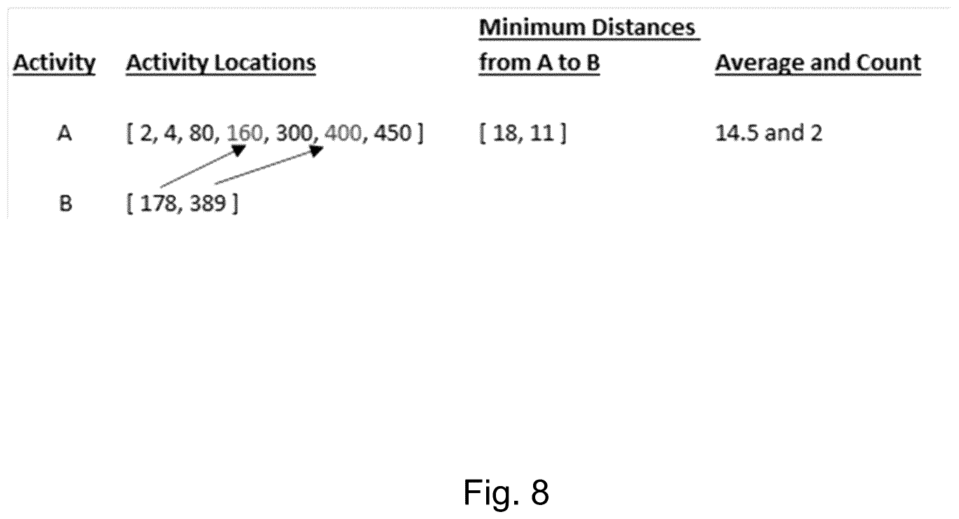

The values in the first matrix on the left represent the average minimum distances from one activity to another for a given resource. The values in the second matrix on the right represent the counts between one activity to another for a given resource. The calculations for these two values are represented in FIG. 8.

For a given resource, suppose the transformation process calculates the average minimum distance and count from activity ‘A’ to activity ‘B’. The first thing that can be done is to determine which activity has the fewest occurrences for the given resource. In FIG. 8, activity ‘B’ happens twice while activity ‘A’ happens seven times, so activity ‘B’ has the fewest occurrences. Next, for each position of activity ‘B’, the transformation process determines the closest occurrence between that position and the positions of activity ‘A’. For activity ‘A’ in FIG. 8, position 160 is closest to the 178 position of activity ‘B’ and position 400 is the closest to the 389 position of activity ‘B’. The transformation process determines the absolute value of the differences between these positions: abs (178−160)=18 and abs (389−400)=11. The process then takes the average of these differences which becomes the value in the distance matrix for the given resource and row ‘A’, column ‘B’, which would be 14.5 in this example. The value for the same cell in the count matrix would simply be the count of the activity with the fewest occurrences, which is 2 corresponding to activity ‘B’.

It will be understood that many different equivalent mathematical operations could be performed to achieve a similar transformation.

### Creation of Matrix of M Activities by M Activities

Referring back to FIG. 2, the next step in the process is the creation of a matrix in block 215. In one implementation, the process of matrix creation includes summing over all the resources over each of the two u×m×m matrices previously created in order to create two m×m matrices. This can be seen in Equation 2 below.

Define D=[dᵢⱼₖ]∈ [symbol] _{m×m×u} and IF=[fᵢⱼₖ]∈ [symbol] _{m×m×u}. We can then calculate I̅D̅=[d̅ᵢⱼₖ]∈ [symbol] _{m×m} as:

$${\overline{d}}_{ij} = \frac{{\sum }_{k = 1}^{u} {d}_{ijk} {f}_{ijk}}{{\sum }_{k = 1}^{u} {f}_{ijk}}$$

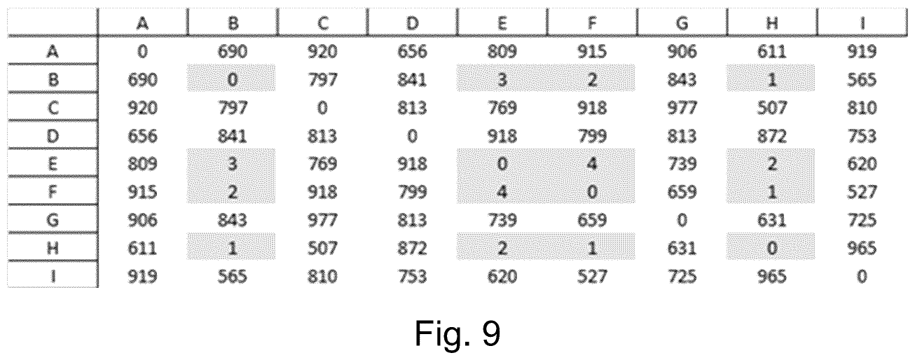

Let dᵢⱼₖ represent the u×m×m distance matrix calculated the previous step, with i and j representing the m×m dimensions (activities) and k representing the resources. Likewise, let fᵢⱼₖ represent the u×m×m count matrix calculated in step 210 of FIG. 2. We sum over the multiplication of dᵢⱼₖ and fᵢⱼₖ and then divide by the sum of fᵢⱼₖ in order to get our final distance matrix (a weighted average) we will use for clustering. An example of this can be seen in FIG. 9.

Consider the value for the row of activity ‘B’ and the column of activity ‘E’. This value can be interpreted as: “the shortest distance between ‘B’ and ‘E’ is 3 events”. If one references the time series data of FIG. 3, this would translate to activities ‘B’ and ‘E’ typically being 3 rows away from one another. This matrix will be used by the clustering algorithm in step 225 of FIG. 2 to cluster the activities into tasks. In this example, the algorithm would likely cluster activities ‘B’, ‘E’, ‘F’ and ‘H’ together since they share a similar pattern of being short distances to one-another.

### Determine Optimal Number of Clusters

Referring back to FIG. 2, the optimal number of clusters needs to be determined 220. A determination must be made of the optimal number of clusters to group the activities into. There are diminishing returns beyond some optimal number of clusters. Various candidate criteria may be used including frequency, number of activities in cluster, and the distance between activities in cluster. A variety of different techniques may be used.

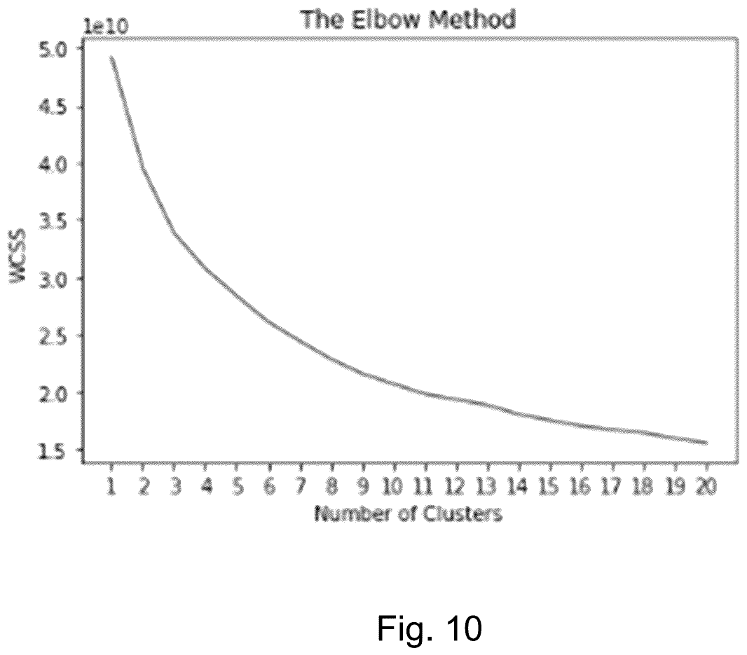

One approach that could be used to determine the optimal number of clusters is referred to as the elbow method, which is illustrated in FIG. 10. This method involves graphing a measure called weighted cluster sum of squares (WCSS) by an increasing number of clusters and seeing where the decrease in WCSS stops paying off as the number of clusters increases. WCSS is a measure of how similar the datapoints within a cluster are to each other. It's a score for how “tight” the cluster is. However, the elbow method has drawbacks for generating task candidates. The elbow method, as conventionally applied, can fail in some circumstances to accurately and reliably guide K-Means to create separate clusters for each task.

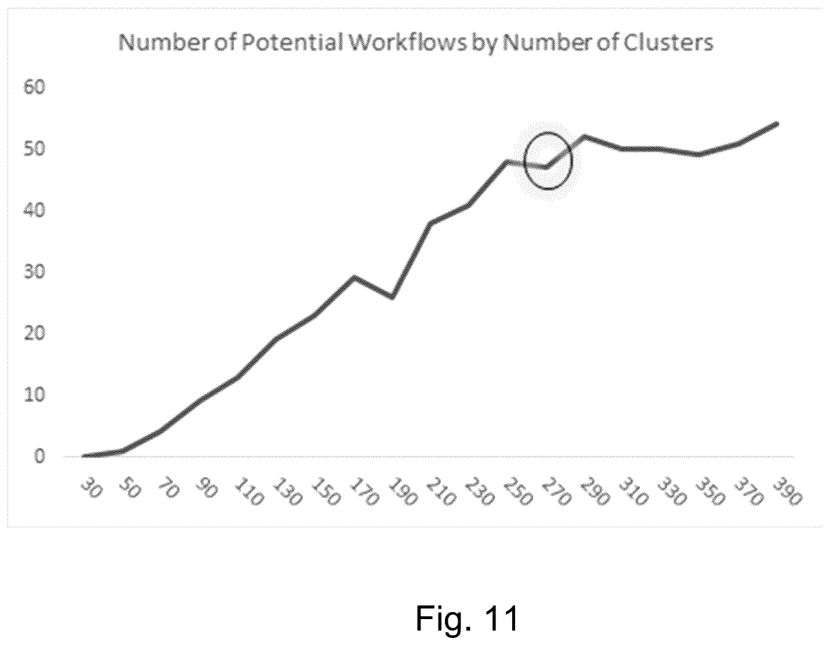

Another technique determines the optimal number of clusters by plotting the number of promising task candidates on the y-axis instead of WCSS and an increasing number of clusters on the x-axis. FIG. 11 shows this plot.

In one implementation, a promising task candidate is defined as a cluster that meets three criteria: 1) meeting a frequency threshold (to ensure it happens enough times to care about), 2) meeting a threshold for the number of activities (so that clusters of 1 or 2 are not considered) and 3) having a median inner distance under a threshold (to ensure the activities don't happen too far apart).

The thresholds specified are arbitrary and up to the user to pre-select. For example, for a particular workforce, the thresholds may be selected (or adjusted) to obtain good results.

The optimal clusters can be determined by the point in which the plot starts to level-off, such as that marked by the circle in FIG. 11. Adding clusters beyond this point doesn't generate that many extra promising task candidates and since having too many clusters can break apart clusters that represent true tasks, it's not beneficial and can be harmful to add additional clusters beyond the “reverse elbow” point.

In one implementation, in order to determine this point, K-means is run iteratively over an increasing number of clusters. In our example, we increased the number of clusters by twenty for each iteration, but this rate of increase can be up to the user. The output of K-means each time is a set of unique clusters which are compared to the three criteria previously mentioned above. For each number of clusters used to specify K-means, both the number of clusters used for K-means and the number of unique clusters passing the three criteria (the number of task candidates) are added to an array.

With the array of increasing cluster counts and passing task candidates, the process can use a variety of different methods to determine the optimal number of clusters. One implementation calculates the slopes of the number of task candidates vs the number of clusters along with a separate list of rolling slopes averaged over a defined window. We determined the point at which the rolling slopes haven't increased for several successive iterations (chosen window length+1 in this example) of an increasing number of clusters and used that point as the optimal number of clusters. Another, more manual, option could be for the user to determine this point visually from a plot like FIG. 11.

### Run Clustering Algorithm

Referring back to FIG. 2, after determining an optima number of clusters, the process then runs a clustering algorithm to generate clusters of candidate tasks in block 225.

In one implementation, a K-Means clustering algorithm is used, where K-Means groups similar data points together, dividing the data in “K” clusters, where K is a specified number. Using the data created by steps 205-215 and the number of clusters determined by step 220, the process can run the clustering algorithms of block 225 to group our activities into clusters. Afterward, the clusters need to be validated to determine which are real processes/tasks. There are two steps to this validation process: 1) assess numeric measures of cluster quality and 2) validate with the client.

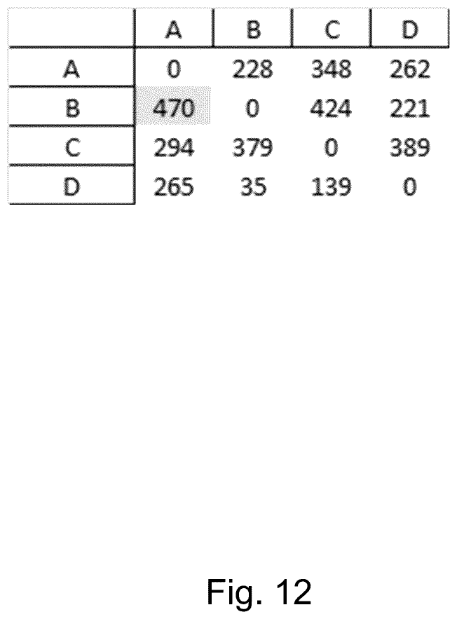

FIG. 12 shows a frequency table for one cluster.

Let's discuss the first step in the validation process which involves two numeric measures. The first is the maximum frequency seen among all the combinations of activities w/in a given cluster. For example, ‘A’, ‘B’, ‘C’, and ‘D’ are all activities within one four-activity cluster, as seen in FIG. 12. The numbers in this table refer to the number of times one activity transitions to another. So, row ‘A’, column ‘B’ in FIG. 12 means that ‘A’ went to ‘B’ 228 times. The maximum transition is from activity ‘B’ to activity ‘A’, which happens 470 times. The 470 metric can be compared to the same metric for other clusters to assess, at least directionally, which clusters happen more often. The more frequently a cluster occurs, the more likely it is to be a true task.

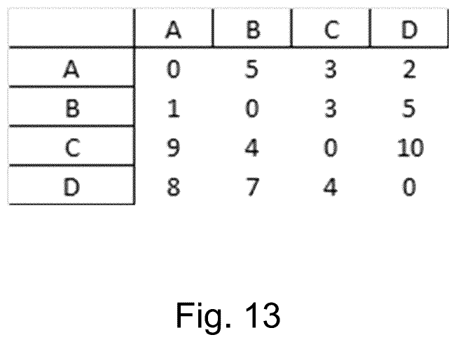

FIG. 13 illustrates a distance table for one cluster. The second metric is the median distance w/in the cluster. Above in FIG. 13, we can see the distances from each activity to another w/in the cluster. The median of the above table is 3.5. The smaller the median distance w/in a cluster, the more likely it is to be a true task. So, this step in the validation process involves identifying the most frequent clusters with the lowest median distance.

Referring back to FIG. 2 and additional optional validation process 230 may be used to verify the candidate tasks. For example, a company manager or a subject matter expert may validate the tasks. Alternatively, a machine learning process could be trained to perform a verification process.

As an example, a validation process can be performed to have human-centered review by a client or a subject matter expert who has the experience to recognize which groups of activities are indeed true tasks that they or their colleagues or direct reports execute on a frequent basis. For example, when showing clusters to the client, the clusters arising from the first step in the validation process should be prioritized and the client should be shown the remaining clusters if time allows.

With true tasks identified, they can be subsequently tagged, which opens the gates to several valuable types of analysis.

The overall method, which has five primary steps, provides a number of advantages and benefits. It can be implemented to handle a massive amount of data. It helps the end user make distinctions between good and bad activity patterns. It can be used to discover tasks in task-mining datasets.

Steps 210 and 215 use data transformations to extract the distances that activities are from one another and using the distances as an input to machine learning algorithms in order to uncover sequences. Step 220 uses the new technique to determine the optimal number of clusters.

Step 225, includes the use of frequency and distance metrics to discern the quality of the clusters/task candidates found. The use of frequency and distance metrics to discern the quality of the clusters/task candidates found could be considered as novel.

The basic five-step approach of FIG. 2 to identifying tasks is novel overall for a few reasons. First, it has the ability to handle an enormous quantity of data. The vast amount of data can span long time-periods and the algorithm can identify tasks w/in these very long sequences arising from task-mining events captured down to the millisecond level. This is very different than dealing with shorter sequences of data like messages exchanged in brief chat sessions which are more in the purview of NLP techniques. Second, the process overall isn't just crunching numbers, it's also helping the user to make distinctions between good and bad activity patterns. Finally, the overall approach is a solution to the business problem of discovering tasks in task-mining datasets consisting of enormous sequences of very granular events.

### Alternate Implementations

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the system and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes, but is not limited to, firmware, resident software, microcode, etc. Furthermore, the technology can take the form of a computer program object accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions and/or formats.

Furthermore, the modules, routines, features, attributes, methodologies, and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A method of task identification in a workforce, comprising:
gathering time series data of resources, computer apps, and computer screens for desktop activities of a workforce;
performing pre-processing of time series data, including filtering the time series data and performing at least one data transformation operation to convert the time series data into a data representing desktop activities, distances between activities, and counts;
generating a matrix of activities from the data representing desktop activities, distances between activities, and counts;
determining an optimum number of clusters for the filtered and transformed data;
clustering the filtered and transformed time series data into the optimum number of clusters; and
generating a list of candidate tasks from the clusters.

2. The method of claim 1, wherein the generating a list of candidate tasks from the clusters is based on a frequency threshold criteria, a minimum number of activities threshold, and a median distance threshold.

3. The method of claim 1, wherein determining an optimum number of clusters comprises plotting task candidates on a y-axis and an increasing number of clusters on an x-axis.

4. The method of claim 1, further comprising assessing numeric measures of cluster quality.

5. The method of claim 1 wherein the transformation operation comprises generating a count matrix and a distance matrix.

6. The method of claim 5, further comprising generating a single matrix from the count matrix and the distance matrix to generate a distance matrix having a weighted average.

7. A method of task identification in a workforce, comprising:
monitoring time series data of resources, computer apps, and computer screens;
filtering the time series data;
performing at least one transformation process to identify distances between activities;
performing clustering to generate a candidate list of tasks.

8. The method of claim 7, wherein the resources comprise at least one of human resources and robotics process automation resources.

9. The method of claim 7, wherein the filtering of the time series data comprises removing non-work activities and duplicative activities.

10. The method of claim 7, wherein the filtering comprises removing activities only encountered by a pre-selected threshold low number of resources.

11. The method of claim 10, wherein the pre-selected threshold low number is one.

12. The method of claim 7, wherein the transformation process comprises determining minimum distances between activities and a count.

13. The method of claim 7, wherein the transformation process comprises generating a distance matrix and a count matrix.

14. The method of claim 13, wherein the transformation process comprises generating a matrix of m activities by m activities.

15. The method of claim 14, wherein the transformation process comprises generating a m×m matrix that includes a weight average of distances.

16. The method of claim 13, wherein the clustering comprises K-means clustering.

17. A method of task identification, comprising:
monitoring desktop activities of a workforce, including monitoring time-series data of workers, applications, and screens used;
filtering the time-series data to filter out non-work related desktop activities;
transforming the time series data into a matrix representation indicative of a distance between activities and frequency of occurrence; and
generating candidate tasks by performing a clustering process and at least one other operation to validate valid tasks.

18. The method of claim 17, further comprising generating a list of valid tasks.

19. The method of claim 17, further comprising generating a list of tasks and analyzing the tasks.
